(19) United States
(12) Patent Application Publication
(10) Pub. No.: US 2007/0030913 A1
(43) Pub. Date: Feb. 8, 2007

(54) Orthogonal frequency division multiplexing receiver capable of canceling impulse interference

(75) Inventor: Che-Li Lin, Taipei City (TW)

Correspondence Address: BIRCH STEWART KOLASCH & BIRCH, PO BOX 747, FALLS CHURCH, VA, 22040-0747, US

(73) Assignee: MEDIATEK INCORPORATION

(21) Appl. No.: 11/196,353

(22) Filed: Aug. 4, 2005

(51) Int. Cl. H04K 1/10

(52) U.S. Cl. 375/260

(57) ABSTRACT

An orthogonal frequency-division multiplexing (OFDM) receiver that has a capability for canceling impulse interference is introduced in the present invention. The OFDM receiver includes an impulse noise remover for receiving incoming signals and canceling the impulse interference and a demodulator to demodulate the incoming signals. The impulse noise remover includes an analog-to-digital converter (ADC) that converts the incoming signals into multiple signal points, a delay line for temporarily storing the signal points, a signal processor for calculating a summation of a number of the signals points, a thresholder for checking if an input level provided by the signal processor according to the summation is greater than a predetermined threshold and a switch for replacing values of the signal points influenced by the impulse interference by zeros if the input level is greater than the predetermined threshold.

### BACKGROUND OF THE INVENTION

1. Field of the Invention

The present invention is related to an orthogonal frequency-division multiplexing (OFDM) receiver, and more particularly, to an OFDM receiver that has a capability for canceling impulse interference.

2. Description of Related Art

Various modulation techniques related to OFDM have been proposed in recent years for transmitting digital signals. With an OFDM system, a transmission band is provided with a number of orthogonally arranged sub-carriers and data are assigned to the amplitude and the phase of each sub-carrier for the purpose of digital modulation by PSK (phase shift keying) or QAM (quadrature amplitude modulation).

With OFDM, while each sub-carrier has a small bandwidth because the transmission band is divided into a number of sub-carriers and hence the modulation speed per sub-carrier is low, the overall transmission rate remains practically same as that of any conventional modulation system. Additionally, OFDM is characterized by a low symbol rate also due to the fact that a number of sub-carriers are used in parallel for signal transmission. Hence, with OFDM, the time length of a multi-path can be reduced relative to that of a symbol in order to reduce the possible interference in the multi-path. Thus, OFDM systems are very suitable for wireless applications.

For this sake, nowadays, OFDM receivers are applied extensively to various wired or wireless digital communication systems, such as ADSL, WLAN, DAB and DVB. However, the OFDM receivers usually need to operate in the environment with impulse interferences caused by other electric appliances, such as a washing machine, a clothing dryer or a car's starter. The impulse interferences may be received via the antenna or transmission line of the OFDM receiver or coupled directly to the circuit board to degrade the communication quality.

Accordingly, the conventional OFDM receiver still has some drawbacks that could be improved upon. The present invention aims to resolve these drawbacks.

### SUMMARY OF THE INVENTION

The present invention provides an OFDM receiver including: an impulse noise remover for receiving incoming signals and canceling the impulse interference; and a demodulator electrically connected to the impulse noise remover to demodulate the incoming signals that have been processed by the impulse noise remover. Therein, the impulse noise remover further includes: an analog-to-digital converter (ADC) that converts the incoming signals into multiple signal points; a delay line for temporarily storing the signal points; a signal processor for calculating a summation of a predetermined number of the signals points; a thresholder for checking if an input level provided by the signal processor according to the summation is greater than a predetermined threshold or not; and a switch for replacing values of the signal points influenced by the impulse interference by zeros if the input level is greater than the predetermined threshold.

Furthermore, the signal processor further has multiple absolute value operators and a summation operator. The absolute value operators are used to calculate absolute values of the signals points and the summation operator is used to add up the absolute values outputted from the absolute value operators to produce the summation.

In addition, the impulse noise remover further has an occurrence counter to count interference occurring times within a predetermined time interval. The demodulator further has a carrier recovery circuit, a timing recovery circuit and a fast Fourier transform (FFT) window selector, whose setting is held if a number of the interference occurring times is larger than a predetermined value. Moreover, the demodulator further has a soft-input viterbi decoder. A value of channel state information (CSI) of the soft-input viterbi decoder is adjusted according to a number of the interference occurring times.

### BRIEF DESCRIPTION OF THE DRAWINGS

FIG. 1 shows a block diagram of an interference-canceling OFDM receiver in accordance with the present invention;

FIGS. 2a-c show some examples of the input waveform of the thresholder;

FIG. 3 shows an operative flowchart of the thresholder of the interference-canceling OFDM receiver in accordance with the present invention;

FIG. 4 is a block diagram of a demodulator in accordance with the present invention; and

FIG. 5 is a flow chart showing the operation of the occurrence counter of the interference-canceling OFDM receiver in accordance with the present invention.

### DETAILED DESCRIPTION OF PREFERRED EMBODIMENTS

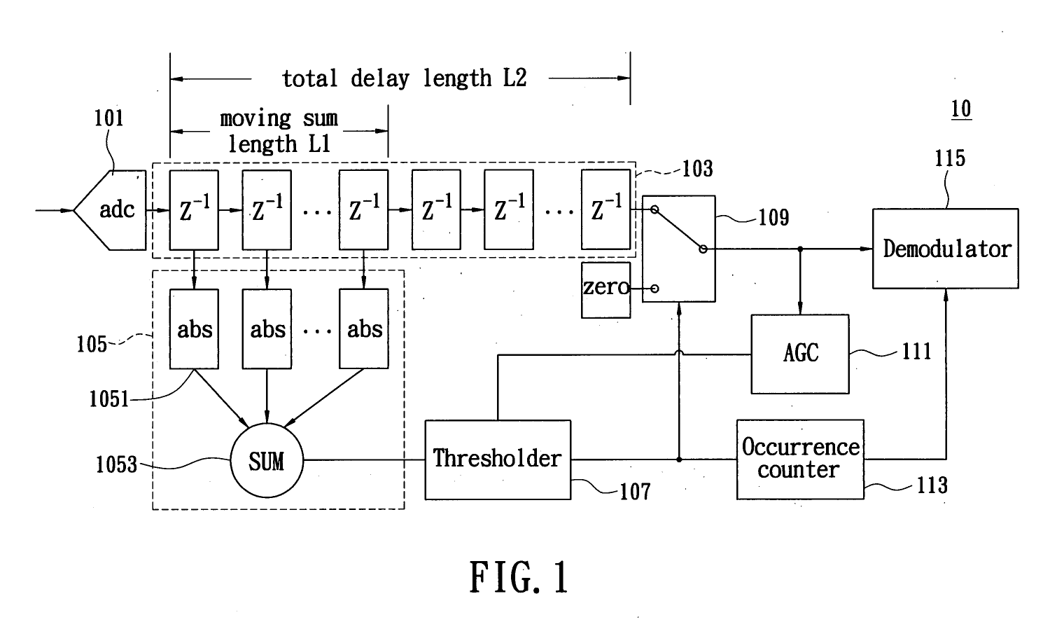

Reference is made to FIG. 1, which shows a block diagram of an interference-canceling OFDM receiver in accordance with the present invention. As shown in the figure, the interference-canceling OFDM receiver 10 includes an impulse noise remover and a demodulator 115. The impulse noise remover has an analog-to-digital converter (ADC) 101, a delay line 103, a signal processor 105, a thresholder 107, a switch 109, an automatic gain controller (AGC) 111 and an occurrence counter 113. Therein, the signal processor 105 includes L1 absolute value operators 1051 and a summation operator 1053.

After wireless OFDM signals are received, they are first passed to the ADC 101 for analog-to-digital conversion. Thus, the OFDM signals are digitalized to produce corresponding digital signals. Then, these digital signals are passed to the delay line 103. The total delay length of the delay line 103 is L2 and hence the delay line 103 is able to keep L2 signal points in total. Every time when the contents of the delay line 103 is moved forward, the first L1 signal points kept in the delay line 103 are passed to the signal processor 105 to obtain a moving sum of the digital signals. The L1 signal points are respectively passed to the absolute value operators 1051 in advance to obtain the absolute values of these signal points. Then, the summation operator 1053 is used to sum up these absolute values to obtain the moving sum of the digital signals.

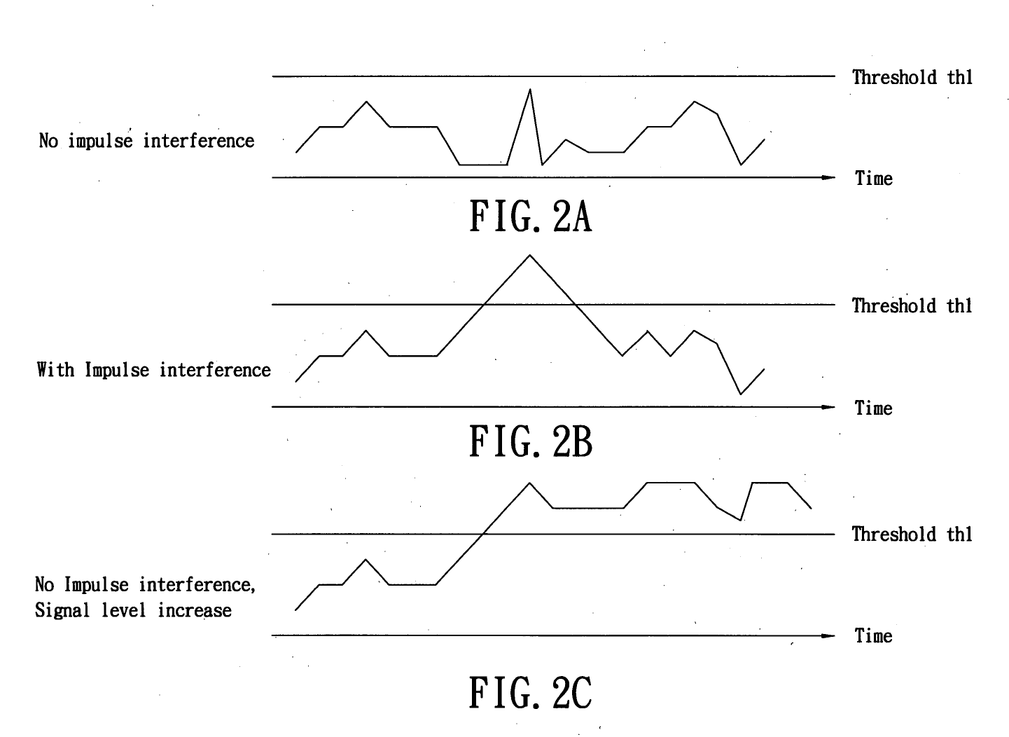

After that, the moving sum of the digital signals is passed to the thresholder 107. Reference is made to FIGS. 2a-c, which show some examples of the input waveform of the thresholder. FIG. 2a shows the normal input waveform. FIG. 2b shows the waveform with impulse interference. FIG. 2c shows the waveform that is affected by the change of the channel gain only. As show in these figures, in general, if there is not impulse interference, the amplitude of the input waveform of the thresholder 107 is smaller than a preset threshold th1. If there is impulse interference, the amplitude of the input waveform is larger than the threshold th1 within a predicted time interval, about 250 ns. If the channel gain is increased, the amplitude of the input waveform is larger than the threshold th1 for a time period much longer that 250 ns.

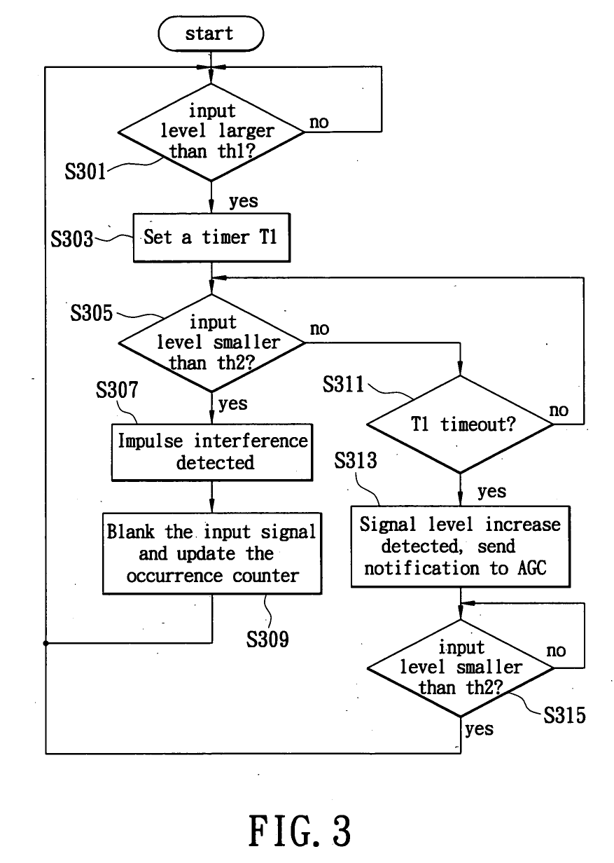

According to the foresaid features, the operative flowchart of the thresholder 107 is designed as shown in FIG. 3. First, the thresholder 107 checks if the input level, i.e. amplitude of the input waveform, is larger than the threshold th1 (S301). If no, go back to step S301. Otherwise, go to step S303 to set a timer T1. Then, the thresholder 107 checks if the input level is smaller than the threshold th2 (S305). It should be noted that the threshold th2 could be the same as or smaller than the threshold th1. If the input level is smaller than the threshold th2, go to step 307. Otherwise, go to step S311. In step 307, the thresholder 107 determines that the impulse interference is detected. Then, the thresholder 107 drives the switch 109 to blanks several signal points of the input signal and updates the occurrence counter 113 (S309). It means the thresholder 107 drives the switch 109 to replace the values of the signal points influenced by the impulse interference by zeros.

In step S311, the thresholder 107 checks if the time T1 is timeout. If no, go back to step S305. Otherwise, go to step S313. In step S313, the thresholder 107 determines that the signal level increase is detected. That means the gain of the AGC 111 is too large. Thus, after the signal level increase is detected, the thresholder 107 sends a notification signal to trigger the AGC 111 to lower its gain so that the amplitude of the incoming signals is kept within a proper range. After that, the thresholder 107 checks if the input level is smaller than the threshold th2 (S315). If yes, go to step S301 to detect another impulse interference. Otherwise, go back to step 315 to make sure the gain of the AGC 111 is lowered. Furthermore, the thresholds th1 and th2 can also be adjusted according to the new gain of the AGC 111.

Since the occurrence frequency of the impulse interference is an important parameter for determining the reliability of the received signals, the occurrence counter 113 is designed to calculate this parameter. The interference-canceling OFDM receiver 10 sets the parameters of the demodulator 115 according to the occurrence frequency of the impulse interference.

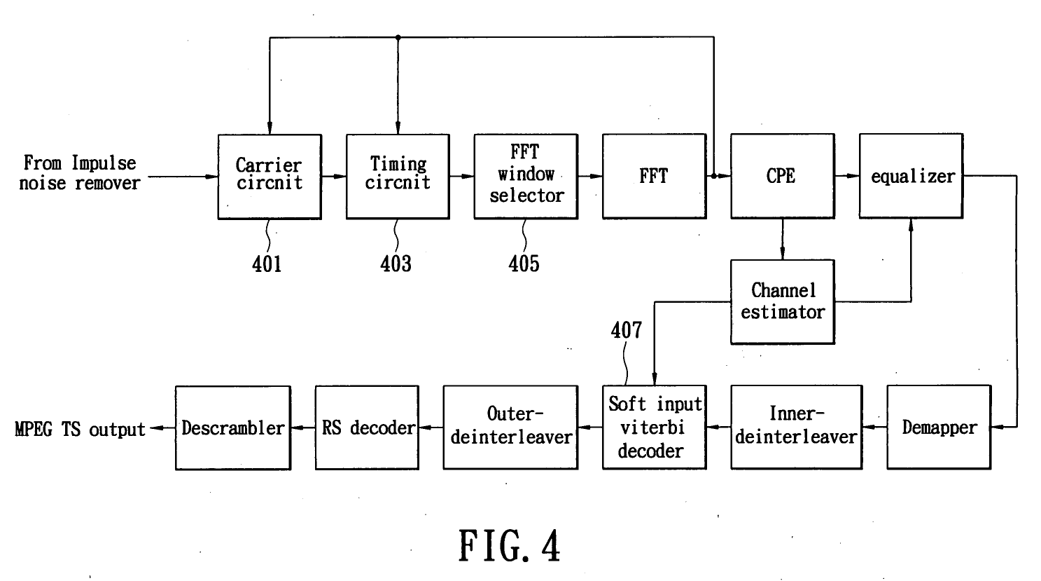

Reference is made to FIG. 4, which is a block diagram of a demodulator in accordance with the present invention. The demodulator 115 shown in FIG. 4 is an embodiment for receiving the signals fitting in with the DVB-T standard. It includes a carrier recovery circuit 401, a timing recovery circuit 403, a fast Fourier transform (FFT) window selector 405, a FFT circuit, a common phase error (CPE) corrector, an equalizer, a channel estimator, a demapper, an inner-deinterleaver, a soft-input viterbi decoder 407, an outer-deinterleaver, a Reed-Solomon (RS) decoder and a decrambler. After processed by the demodulator 115, the signals received externally are demodulated to form a MPEG transport stream (TS).

Since most of the components of the demodulator 115 shown in FIG. 4 are commonly used in the prior art, they are not described in detail. In the present invention, the demodulator 115 controls the carrier recovery circuit 401, the timing recovery circuit 403, the FFT window selector 405 and the soft-input viterbi decoder 407 according to the parameter of the occurrence frequency of the impulse interference obtained from the occurrence counter 113.

When the impulse interference occurs too frequently, the demodulator 115 makes the setting of the carrier recovery circuit 401, the timing recovery circuit 403 and the FFT window selector 405 fixed for a predetermined time period. That action is to prevent these three components from being adjusted according to the unreliable output of the FFT circuit and thus prevent the performance of the system from being degraded. Furthermore, when impulse interference occurs, the equivalent signal-to-noise ratio (SNR) of the received signals is degraded. The demodulator 115 also delivers the parameter of the interference occurrence frequency to the soft-input viterbi decoder 407 to increase the correction rate of decoding.

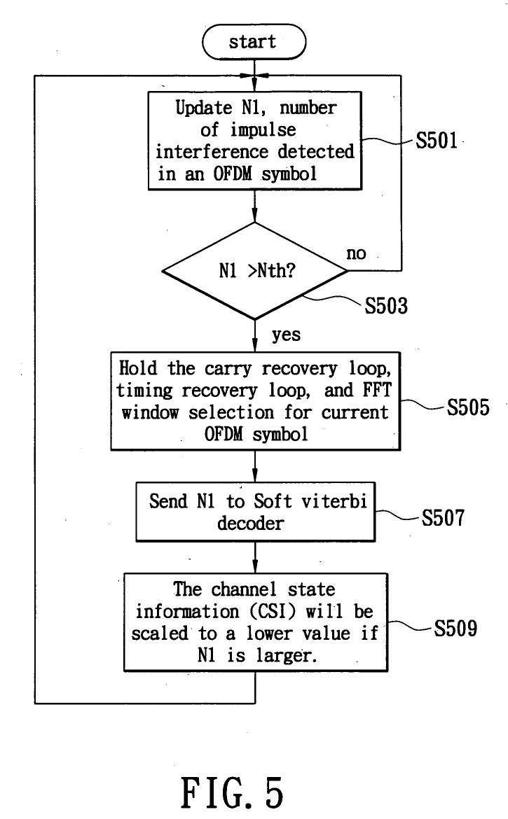

In order to further clarify the operation of the occurrence counter 113, reference is made to FIG. 5, which is a flow chart showing the operation of the occurrence counter in accordance with the present invention. As shown in the figure, the operation of the occurrence counter 113 has following steps. First, every time when triggered by the thresholder 107, the occurrence counter 113 updates parameter N1 recorded therein (S501). The parameter N1 is a number of impulse interference detected in an OFDM symbol. Then, the occurrence counter 113 checks if the parameter N1 is greater than a predetermined threshold Nth (S503). If no, go back to step S501. Otherwise, go to step S505. In step S505, the occurrence counter 113 informs the demodulator 115 to hold the carrier recovery circuit 401, the timing recovery circuit 403 and the FFT window selector 405 for an OFDM symbol received currently (S505). After that, the parameter N1 is sent to the soft-input viterbi decoder 407 (S507) to change the channel state information (CSI) of the soft-input viterbi decoder 407 (S509). In the present invention, if the value of the parameter N1 is larger, the CSI will be scaled to a smaller value. In this way, the impact of the unreliable incoming signals due to impulse interference for the soft-input viterbi decoder 407 is reduced. Thus, the correction rate of the soft-input viterbi decoder 407 is improved.

To sum up, the present invention provides an OFDM receiver that has a capability for canceling impulse interference. First, the present invention uses a signal processor to calculate a summation of absolute values of several signal points produced via an analog-to-digital converter (ADC). Then, a thresholder is used to check whether the input waveform that is provided by the ADC according to the summation is greater than a predetermined threshold to detect whether there is impulse interference or not. If the impulse interference occurs, the present invention replaces the values of the signal points influenced by the impulse interference by zeros and updates an occurrence counter that is used to count interference occurring times within a predetermined time interval. If the impulse interference occurs too frequently, the present invention holds a carrier recovery circuit, a timing recovery circuit and a FFT window selector of a demodulator to prevent the setting of these components from being severely influenced by the impulse interference. Moreover, the present invention also delivers the number of the interference occurring times to a soft-input viterbi decoder of the demodulator to increase the correction rate of decoding. Thereby, the present invention cancels the influence of the impulse interference.

What is claimed is:

1. An orthogonal frequency-division multiplexing (OFDM) receiver for canceling impulse interference, comprising:
an impulse noise remover for receiving incoming signals and canceling the impulse interference; and
a demodulator electrically connected to the impulse noise remover to demodulate the incoming signals that have been processed by the impulse noise remover;
wherein the impulse noise remover further comprises:
an analog-to-digital converter (ADC) that converts the incoming signals into multiple signal points;
a delay line for temporarily storing the signal points;
a signal processor for calculating a summation of a predetermined number of the signals points;
a thresholder for checking if an input level provided by the signal processor according to the summation is greater than a predetermined threshold or not; and
a switch for replacing values of the signal points influenced by the impulse interference by zeros if the input level is greater than the predetermined threshold.

2. The OFDM receiver as claimed in claim 1, wherein the signal processor further has multiple absolute value operators and a summation operator, the absolute value operators are used to calculate absolute values of the signals points and the summation operator is used to add up the absolute values outputted from the absolute value operators to produce the summation.

3. The OFDM receiver as claimed in claim 1, wherein the impulse noise remover further has an occurrence counter to count interference occurring times within a predetermined time interval.

4. The OFDM receiver as claimed in claim 3, wherein the demodulator further has a carrier recovery circuit, a timing recovery circuit and a fast Fourier transform (FFT) window selector, whose setting is held if a number of the interference occurring times is larger than a predetermined value.

5. The OFDM receiver as claimed in claim 3, wherein the demodulator further has a soft-input viterbi decoder, a value of channel state information (CSI) of the soft-input viterbi decoder is adjusted according to a number of the interference occurring times.

6. The OFDM receiver as claimed in claim 1, wherein the impulse noise remover further has an automatic gain controller (AGC), a value of gain of the AGC is adjusted if an input level provided by the signal processor according to the summation is continuously greater than a predetermined threshold exceeding a predetermined time limit.

7. An impulse noise remover for canceling impulse interference, comprising:
an analog-to-digital converter (ADC) that converts incoming signals into multiple signal points;
a delay line for temporarily storing the signal points;
a signal processor for calculating a summation of a predetermined number of the signals points;
a thresholder for checking if an input level provided by the signal processor according to the summation is greater than a predetermined threshold or not; and
a switch for replacing values of the signal points influenced by the impulse interference by zeros if the input level is greater than the predetermined threshold.

8. The impulse noise remover as claimed in claim 7, wherein the signal processor further has multiple absolute value operators and a summation operator, the absolute value operators are used to calculate absolute values of the signals points and the summation operator is used to add up the absolute values outputted from the absolute value operators to produce the summation.

9. The impulse noise remover as claimed in claim 7, further comprising an occurrence counter to count interference occurring times within a predetermined time interval.

10. The impulse noise remover as claimed in claim 9, wherein impulse noise remover outputs the signals points or zeros to a demodulator for signal demodulation, the demodulator further has a carrier recovery circuit, a timing recovery circuit and a FFT window selector, whose setting is held if a number of the interference occurring times is larger than a predetermined value.

11. The impulse noise remover as claimed in claim 9, wherein impulse noise remover outputs the signals points or zeros to a demodulator for signal demodulation, the demodulator further has a soft-input viterbi decoder, a value of channel state information (CSI) of the soft-input viterbi decoder is adjusted according to a number of the interference occurring times.

12. The impulse noise remover as claimed in claim 7, further comprising an automatic gain controller (AGC), wherein a value of gain of the AGC is adjusted if an input level provided by the signal processor according to the summation is continuously greater than a predetermined threshold exceeding a predetermined time limit.
